(19) United States
(12) Patent Application Publication
(10) Pub. No.: US 2008/0032643 A1
(43) Pub. Date: Feb. 7, 2008

(54) Methods and apparatus for providing input voltages to power amplifiers

(75) Inventors: Ping Liu, South Surrey (CA); Alan D. McGrath, Delta (CA)

Correspondence Address: Robert E. Krebs;THELEN REID & PRIEST LLP, P.O. Box 640640, San Jose, CA, 95164-0640, US

(73) Assignee: Sierra Wireless, Inc. a Canadian corp.

(21) Appl. No.: 11/490,664

(22) Filed: Jul. 20, 2006

(51) Int. Cl. H04B 1/04; H01Q 11/12

(52) U.S. Cl. 455/127.1

(57) ABSTRACT

A method and apparatus for providing input voltages to power amplifiers (PAs) is disclosed. For one embodiment, a multiple-mode device having a corresponding PA for each mode is provided with a voltage adjustment mechanism that adjusts the output voltage from the switcher based upon the PA that is currently in use. The voltage adjustment mechanism may be controlled by firmware or software of a digital processing system (DPS) of the host device. The voltage adjustment mechanism may include a digital potentiometer controlled by the host DPS.

### FIELD

Embodiments of the invention relate generally to the field of electronic devices containing one or more power amplifiers (PAs) and more specifically to methods and apparatuses for providing power to such devices.

### BACKGROUND

Many devices implement one or more PAs to provide required power output. For example, recently devices such as wireless mobile devices are being designed to support multiple frequency bands and air links or other features. Such devices may support a variety of operational modes including a time division multiple access (TDMA) mode (e.g., PHS, PDC, ISI36, and GSM) or code division multiple access (CDMA) mode (e.g., CDMA 2000, TD-SCDMA, and UMTS), as well as WiFi (a wireless local area network (WLAN) compatibility specification), and WiMAX functionality. In many cases a PA for each mode may be implemented on the device with each of multiple PAs having a distinct optimal operating voltage. Each PA may require a specific (and different) input voltage in order to operate efficiently. The efficiency of the PA is measured by the ability of the PA to convert DC power to RF power; greater efficiency yields more power converted to RF energy and less energy converted to heat.

Typically devices are designed with a single power supply and hence a single input voltage. This input voltage may be optimized for one of the PAs, but not for one or more other PAs. Designers typically implement a power supply to provide the required input voltage for the PA having the highest voltage requirements and allow the other PAs to operate at reduced efficiency. For example, if a first PA implemented on a device requires 3.6 V and second PA implemented on the device requires 3.3 V, then an input voltage of approximately 3.6 V is provided. The second PA may operate at approximately 15% reduced efficiency.

This design tradeoff is disadvantageous in that a PA that operating at reduced efficiency generates additional heat in the device and reduces battery life. Moreover, the disadvantages will be compounded as the device complexity increases. That is, as more PAs are implemented on the device to support more operational modes, the number of PAs operating inefficiently will increase.

Another disadvantage of typical devices implementing a PA is the difference between the operational voltage of the PA and the input voltage of the host device. For example, some devices have a fixed voltage supply that is lower than the required operation voltage of the PA. A switching power supply may be used to increase the input voltage to the desired level. For example, a boost regulator boosts the regulator input voltage to provide an increased output voltage. Buck regulators can be employed as step-down regulators for converting higher input voltages to lower output voltages. The buck-boost converter is a type of DC-DC converter that has an output voltage magnitude that is either greater than or less than the input voltage magnitude. It is a switch mode power supply with a similar circuit topology to the boost converter and the buck converter. The output voltage is adjustable based on the duty cycle of the switching transistor.

However, such implementations have drawbacks in that if the difference between the input voltage and output voltage is not sufficient (e.g., 200 mV), the switcher cannot regulate the voltage as designed and may become unstable or overheat. Therefore, a host device with a power supply providing a nominal 3.3V may have a tolerance of 10% so that the input voltage varies between 3.0V and 3.6V. If the PA has an operational voltage of 3.6V, there may not be sufficient difference in voltage for the switcher to operate.

### SUMMARY

In accordance with one embodiment of the invention a circuit is provided that includes a voltage regulator configured to provide voltage to a plurality of power amplifiers. Each power amplifier having a respective specific operational voltage level and corresponding to a mode of operation of a host device. The circuit also has a mode of operation selection mechanism for selecting a mode of operation of the host device and a voltage adjustment mechanism to adjust an output voltage of the voltage regulator based upon the selected mode of operation.

Other features and advantages of embodiments of the present invention will be apparent from the accompanying drawings, and from the detailed description, that follows below.

### DESCRIPTION OF THE DRAWINGS

The invention may be best understood by referring to the following description and accompanying drawings that are used to illustrate embodiments of the invention. In the drawings:

FIG. 1 illustrates a circuit in which voltage is provided to a PA in accordance with one embodiment of the invention;

FIG. 2 illustrates a process for providing input voltage to a PA in accordance with one embodiment of the invention;

FIG. 3 illustrates a circuit in which a voltage adjustment mechanism is implemented to provide stable operation of a booster switcher in accordance with one embodiment of the invention; and

FIG. 4 illustrates a functional block diagram of a digital processing system in accordance with one embodiment of the invention.

### DETAILED DESCRIPTION

A method and apparatus for providing input voltages to power amplifiers is disclosed. For one embodiment of the invention, a device having multiple PAs is provided with a voltage adjustment mechanism that adjusts the output voltage from the voltage regulator (switcher) based upon the PA that is currently in use. For one embodiment, a multiple-mode device has a corresponding PA for each mode. When a mode is selected, the voltage adjustment mechanism adjusts the voltage based upon the corresponding PA. For one embodiment of the invention the voltage adjustment mechanism is controlled by firmware or software of a digital processing system (DPS) of the host device. For one embodiment of the invention, the voltage adjustment mechanism includes a digital potentiometer controlled by the host DPS. Additionally, or alternatively, embodiments of the invention may include a voltage detector/comparator to determine the input voltage of the switcher and adjusts the input voltage if the input voltage is above a specified maximum value. For one embodiment of the invention, the maximum specified value is determined by the input voltage specification of the switcher. For one embodiment of the invention, the input voltage and output voltage are compared and the input voltage adjusted if the output voltage is not sufficiently greater than the input voltage.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable to devices that implement PAs including wireless communications devices implementing multiple PAs having differing operational voltages.

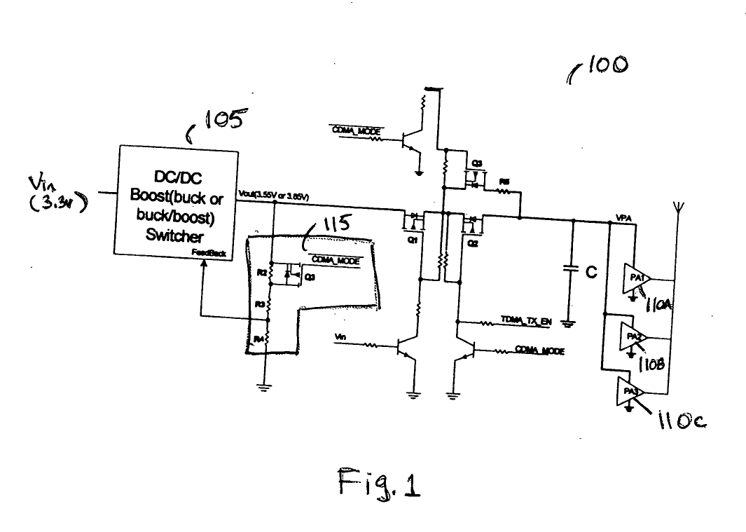

FIG. 1 illustrates a circuit in which voltage is provided to a PA in accordance with one embodiment of the invention. Circuit 100, shown in FIG. 1, includes a switcher 105, which may be, for example, buck or buck boost switcher. Circuit 100 also includes multiple PAs, shown for example as PAs 110A-110C, which have different operational voltages. In accordance with one embodiment of the invention, resistors R2, R3, and R4 together with transistor Q3 function as a variable feedback network 115 that provides a voltage adjustment mechanism to adjust the voltages to each of the PAs 110A-110C. For example, if the device is operating in a given operational mode (e.g., CDMA operational mode) requiring 3.55V, then transistor Q3 is turned on and Vout is provided at 3.55V. With transistors Q1 and Q2 on, a stable input voltage to the PA (VPA) of 3.55V is provided. If the device is operating in a different operational mode (e.g., TDMA operational mode) requiring 3.85V, transistor Q3 is turned off and a VPA of 3.85V is provided. (TDMA mode may have a high power burst transmit and boosting its PA voltage provides some compensation for the voltage drop during transmit).

For one embodiment of the invention, a DPS of the device (not shown) executes software or firmware that operates as an operational mode selection mechanism and determines which operational mode has been selected. The DPS controls the feedback network circuit in accordance with the operational mode selected.

It will be readily apparent to those skilled in the art that for devices implementing multiple PAs requiring more than two different input voltage levels, a more complicated feedback network circuit can be implemented to provide three or more voltage levels to different PAs. For one embodiment of the invention, a digital potentiometer is implemented in place of the feedback network to provide several different VPAs as directed by the DPS. For example, a digital potentiometer may be substituted for resistor R2 in order to provide multiple different resistance values within the feedback network and thus provide multiple output voltages.

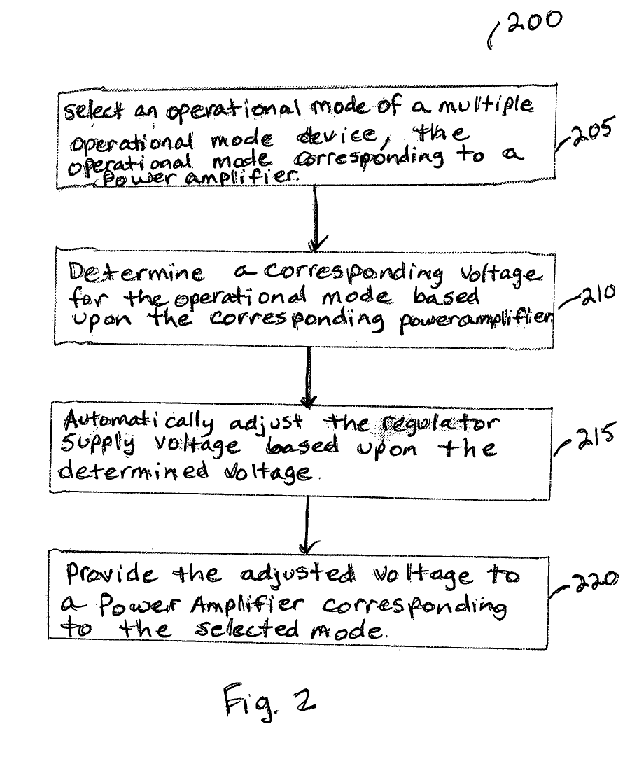

FIG. 2 illustrates a process for providing input voltage to a PA in accordance with one embodiment of the invention. Process 200, shown in FIG. 2, begins at operation 205 in which a particular operational mode is selected for a device having more than one operational mode. The operational mode may be selected by a user of the device or may be automatically selected by a DPS of the device based upon operational mode selection criteria. Each of the operational modes of the multiple operational mode device corresponds to a particular PA. Each PA may have a different operational voltage.

At operation 210 a voltage corresponding to the selected mode is determined. The determined voltage may be a voltage that is within a specified range of operational voltage for a PA corresponding to the selected mode. For example, if TDMA mode is selected and the PA in use for TDMA mode has a specified operational voltage range of 3.84V-3.86V, then the determined voltage may be 3.85V.

At operation 215 a voltage adjustment mechanism is employed to adjust the output voltage of the switcher to the determined voltage. For one embodiment of the invention, the voltage adjustment mechanism may be a digital potentiometer controlled by software executed by a DPS of the device. For one such embodiment, the potentiometer is automatically adjusted based on the selected operational mode of the device. The potentiometer in turn tunes the switcher power supply to supply a voltage based on and optimized for the particular PA used for the selected operational mode. As discussed above, there are many different ways of implementing a voltage adjustment mechanism to adjust the voltage from the power supply based upon the selected operational mode of the device.

At operation 220 the power supply provides input voltage to the PA based upon the operation of the voltage adjustment mechanism. For one embodiment of then invention, the PA operates more efficiently because the input voltage from the power supply has been adjusted to more closely match the optimal operating voltage of the power supply.

During subsequent operation of the device, if a different mode of operation is selected, the operations of process 200 are repeated to adjust the voltage from the power supply to more closely match the optimal operational voltage of the PA corresponding to the subsequently selected mode of operation.

As discussed above, an embodiment of the invention includes a voltage detector/comparator to determine the input voltage of the switcher and adjusts the input voltage if the input voltage is above a specified maximum value. For one such embodiment of the invention, the specified maximum value is determined by the input voltage specification of the switcher. For one embodiment of the invention, the input voltage and output voltage are compared and the input voltage adjusted if the output voltage is not sufficiently greater than the input voltage.

As shown in FIG. 1, the input voltage Vin is at 3.3 V, in such a case the switcher regulates the voltage as designed and does not become unstable or produce excessive heat. However, practically, the input voltage is provided by a power supply that may supply varying voltage (i.e., Vin may range from approximately 3.0V to approximately 3.6V. If Vin is not sufficiently lower than Vout (e.g., approximately 200 mV) the switcher may become unstable and overheat. In accordance with one embodiment of the invention, a voltage adjustment mechanism is implemented in the circuit to adjust the value of Vin to be sufficiently lower than Vout.

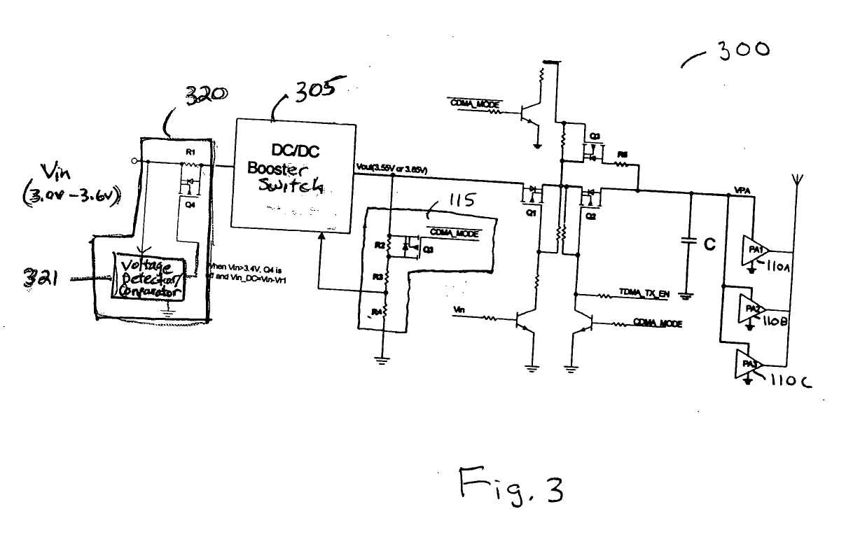

FIG. 3 illustrates a circuit in which a voltage adjustment mechanism is implemented to provide stable operation of a booster switcher in accordance with one embodiment of the invention. Circuit 300, shown in FIG. 3, includes voltage adjustment mechanism 320 that adjusts the input voltage to the booster switch 305. The voltage adjustment mechanism 320 adjusts Vin so that a threshold difference is maintained between Vin and Vout. The threshold difference may be based on the operational specifications of the booster switch 305. The voltage adjustment mechanism 320 includes a voltage detector/comparator 321 that detects the voltage Vin and compares Vin to Vout. If Vin is within a specified threshold difference of Vout, then transistor Q4 is turned off. This adds resistance value R1 in series thus lowering Vin. For one embodiment of the invention, the value of R1 is chosen such that the addition of R1 in series drops Vin by the specified tolerance of the power supply (e.g., 10% of the nominal voltage).

As discussed above in reference to the voltage adjustment mechanism 115, the voltage adjustment mechanism may be implemented in variety of ways which will be apparent to those skilled in the art. R1 could be a power resistor, diode, transistor, or any other device or combination of devices capable of creating the required voltage drop and deliver current to the voltage detector/comparator 321. When Vin exceeds a specified threshold voltage, the output from the voltage detector/comparator 321 turns transistor Q4 off and reduces the input voltage to the booster switch 305. Alternative embodiments of the invention may include a digital potentiometer controlled by software or firmware executed by a DPS of the device. Such an embodiment would allow the input voltage to be dropped by a desired and variable amount based upon the output voltage of the switcher.

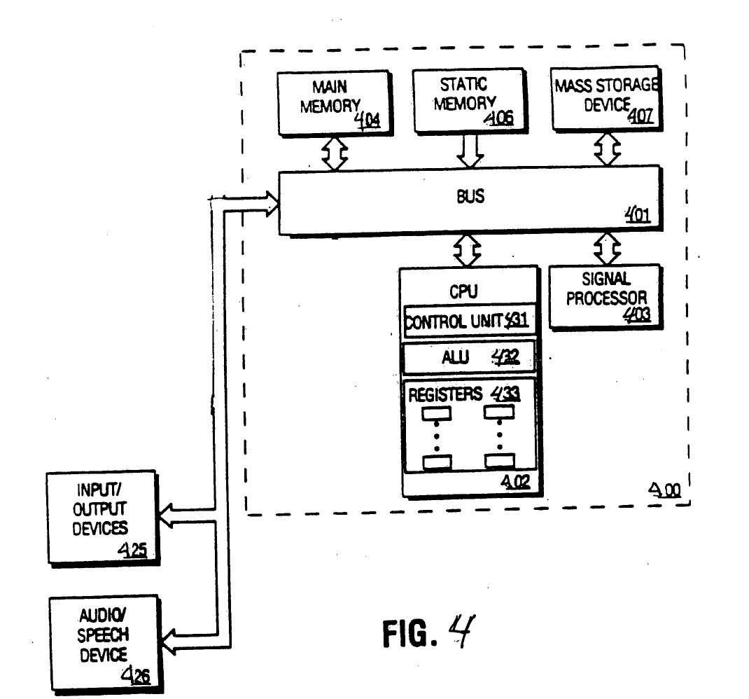

FIG. 4 illustrates a functional block diagram of a digital processing system in accordance with one embodiment of the invention. The components of processing system 400, shown in FIG. 4 are exemplary in which one or more components may be omitted or added. For example, one or more memory devices may be utilized for processing system 400.

Referring to FIG. 4, processing system 400 includes a central processing unit 402 and a signal processor 403 coupled to a main memory 404, static memory 406, and mass storage device 407 via bus 401. In accordance with an embodiment of the invention, main memory 404 may store a selective communication application, while mass storage devise 407 may store various digital content as discussed above. Processing system 400 may also be coupled to input/output (I/O) devices 425, and audio/speech device 426 via bus 401. Bus 401 is a standard system bus for communicating information and signals. CPU 402 and signal processor 403 are processing units for processing system 400. CPU 402 or signal processor 403 or both may be used to process information and/or signals for processing system 400. CPU 402 includes a control unit 431, an arithmetic logic unit (ALU) 432, and several registers 433, which are used to process information and signals. Signal processor 403 may also include similar components as CPU 402.

Main memory 404 may be, e.g., a random access memory (RAM) or some other dynamic storage device, for storing information or instructions (program code), which are used by CPU 402 or signal processor 403. Main memory 404 may store temporary variables or other intermediate information during execution of instructions by CPU 402 or signal processor 403. Static memory 406, may be, e.g., a read only memory (ROM) and/or other static storage devices, for storing information or instructions, which may also be used by CPU 402 or signal processor 403. Mass storage device 407 may be, e.g., a hard disk drive or optical disk drive, for storing information or instructions for processing system 400.

### General Matters

Embodiments of the invention include methods apparatuses for automatically adjusting the voltage from the power supply based a selected operation mode corresponding to one of multiple power supplies. For one embodiment of the invention the voltage adjustment mechanism may be implemented as a variable feedback network. For one such embodiment of the invention, the voltage adjustment mechanism is implemented as a hardwired resistor/transistor circuit in which one or more transistors are opened or closed to create a combination of resistance corresponding to a voltage determined for a selected mode of operation with the selected mode information provide to the circuit by a DPS of the device. For alternative Alternatively, the voltage adjustment mechanism may be implemented as a digital potentiometer or as a power supply with adjustable voltage output. For one embodiment of the invention, the voltage adjustment mechanism is controlled by software or firmware executed by a DPS of the device.

Embodiments of the invention may also include a voltage adjustment mechanism that adjusts the input voltage to the switcher to maintain a specified difference between input voltage and output voltage so that the switcher maintains stable operation. For one embodiment of the invention, a switcher output voltage adjustment mechanism (e.g., voltage adjustment mechanism 115) is implemented to adjust the output voltage of the switcher based upon a selected operational mode and corresponding PA and a switcher input voltage adjustment mechanism (e.g., voltage adjustment mechanism 320) is implemented to adjust the input voltage to provide stable switcher operation (e.g., to adjust the input voltage so that a differential is maintained between switcher input voltage and switcher output voltage).

Or for example, as described above in reference to FIG. 3, the input voltage to the booster switch is detected and compared to the output voltage of the switcher. In alternative embodiments of the invention, the input voltage need not be compared to the output voltage, instead, if the input voltage exceeds a specified threshold, then the voltage adjustment mechanism drops the input voltage by a specified amount. For one embodiment of the invention the specified threshold voltage may be the nominal voltage of the input power supply (e.g., 3.3V) or may be based upon such value (e.g., nominal value plus 3%). The amount by which the input voltage is dropped may be based upon the specifications of the switcher. Both values may be calculated based upon the specifications of the input power supply and the switcher. For example, if the input power supply operates at 3.3V (+/−10%) and the switcher operates at 3.6V and specifies a difference between Vin and Vout of at least 200 mV, then the threshold for voltage drop may be set to 3.4V and the amount of voltage drop set to 200 mV.

Embodiments of the invention have been described as including various operations. Many of the processes are described in their most basic form, but operations can be added to or deleted from any of the processes without departing from the scope of the invention. For example, as described in reference to FIG. 2, an embodiment of the invention includes determining a voltage corresponding to a selected mode at operation 210. For one embodiment of the invention, a desired voltage corresponding to each mode is predetermined and based upon the specifications of the PA used for each respective mode. For such an embodiment, operation 210 may be reduced to automatically selecting the predetermined voltage.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A circuit comprising:
a voltage regulator configured to provide voltage to a plurality of power amplifiers, each power amplifier having a respective specific operational voltage level, each power amplifier corresponding to a mode of operation of a host device;
a mode of operation selection mechanism for selecting a mode of operation of the host device; and
a voltage adjustment mechanism to adjust an output voltage of the voltage regulator based upon the selected mode of operation.

2. The circuit of claim 1 wherein the output voltage of the voltage regulator is within a threshold value of the specific operational voltage level of the power amplifier corresponding to the selected mode of operation.

3. The circuit of claim 1 wherein the voltage adjustment mechanism includes a digital potentiometer controlled by a digital processing system implemented on the host device.

4. The circuit of claim 1 further comprising:
a second voltage adjustment mechanism configured to adjust the input voltage of the voltage regulator to be a specified difference from the output voltage of the voltage regulator.

5. The circuit of claim 4 wherein the second voltage regulator is configures to compare an input voltage from a power supply and the output voltage of the voltage regulator.

6. The circuit of claim 1 wherein the host device is a wireless communications device and the modes of operation of the device are wireless communications system protocols.

7. The circuit of claim 6 wherein the wireless communications system protocols include TDMA, CDMA, GSM, WiFi, Bluetooth, PHS, PDC, CDMA 2000, SCDMA, UMTS and combinations thereof.

8. A system comprising:
a processor for determining and selecting an operational mode of a host device having a plurality of operational modes, each operational mode corresponding to a power amplifier having a respective specific operational voltage level;
a voltage regulator for providing voltage to each power amplifier; and
a voltage adjustment mechanism configured to adjust an output voltage of the voltage regulator based upon a selected mode of operation.

9. The system of claim 8 wherein the output voltage of the voltage regulator is within a threshold value of the specific operational voltage level of the power amplifier corresponding to the selected mode of operation.

10. The circuit of claim 8 wherein the voltage adjustment mechanism includes a digital potentiometer controlled by a digital processing system implemented on the host device.

11. The system of claim 8 further comprising:
a second voltage adjustment mechanism configured to adjust the input voltage of the voltage regulator to be a specified difference from the output voltage of the voltage regulator.

12. The system of claim 11 wherein the second voltage regulator is configures to compare an input voltage from a power supply and the output voltage of the voltage regulator.

13. The system of claim 8 wherein the host device is a wireless communications device and the modes of operation of the device are wireless communications system protocols.

14. The system of claim 13 wherein the wireless communications system protocols include TDMA, CDMA, GSM, WiFi, Bluetooth, PHS, PDC, CDMA 2000, SCDMA, UMTS and combinations thereof.

15. A machine-readable medium that provides executable instructions, which when executed by a processor, cause the processor to perform a method, the method comprising:
selecting a mode of operation of a host device having a plurality of operational modes, each operational mode corresponding to a power amplifier having a respective specific operational voltage level;
determining the operational voltage level of the power amplifier corresponding to the selected mode of operation;
automatically adjusting the output voltage of a voltage regulator configured to provide voltage to a plurality of power amplifiers.

16. The machine-readable medium of claim 15 wherein the output voltage of a voltage regulator is adjusted using a voltage adjustment mechanism implemented on the host device.

17. The machine-readable medium of claim 15 wherein the output voltage of the voltage regulator is within a threshold value of the specific operational voltage level of the power amplifier corresponding to the selected mode of operation.

18. The machine-readable medium of claim 15 wherein automatically adjusting the output voltage of a voltage regulator includes controlling a digital potentiometer.

19. The machine-readable medium of claim 15 wherein the method further comprises:
automatically adjusting the input voltage of the voltage regulator to be a specified difference from the output voltage of the voltage regulator.

20. The machine-readable medium of claim 18 wherein the second voltage regulator is configures to compare an input voltage from a power supply and the output voltage of the voltage regulator.

21. The machine-readable medium of claim 15 wherein the host device is a wireless communications device and the modes of operation of the device are wireless communications system protocols.

22. The machine-readable medium of claim 20 wherein the wireless communications system protocols include TDMA, CDMA, GSM, WiFi, Bluetooth, PHS, PDC, CDMA 2000, SCDMA, UMTS and combinations thereof.
